(19) United States
(12) Patent Application Publication
(10) Pub. No.: US 2023/0367261 A1
(43) Pub. Date: Nov. 16, 2023

(54) HOLOGRAPHIC PRINTING DEVICE AND METHOD USING MULTIPLE OPTICAL HEADS

(71) Applicant: Korea Electronics Technology Institute, Seongnam-si (KR)

(72) Inventors: Sung Hee HONG, Seoul (KR); Young Min KIM, Seoul (KR); Ji Soo HONG, Seoul (KR); Jin Soo JEONG, Seoul (KR)

(73) Assignee: Korea Electronics Technology Institute, Seongnam-si (KR)

(21) Appl. No.: 18/030,093

(22) PCT Filed: Dec. 2, 2020
(86) PCT No.: PCT/KR2020/017424

§ 371 Date: Apr. 4, 2023

(30) Foreign Application Priority Data
Dec. 2, 2020 (KR) 10-2020-0166174

(51) Int. Cl. G03H 1/04

(52) U.S. Cl. CPC G03H 1/0476; G03H 2223/53

(57) ABSTRACT

Provided are a holographic printing device and method using multiple optical heads. The holographic printing device according to an embodiment of the present invention comprises: a fringe pattern generation unit which generates a holographic fringe pattern, and segments the generated fringe pattern into hogels; a multiplexing unit which groups the hogels, segmented by the fringe pattern generation unit, according to area; and a plurality of optical heads which respectively receive the grouped hogels and print the respective hogels in the corresponding areas of a holographic medium. Accordingly, several hogels can be printed on the holographic medium at a time using the multiple optical heads, thus reducing holographic printing time so that even large screen holograms can be printed at high speed.

### TECHNICAL FIELD

The disclosure relates to a hologram-related technology, and more particularly, to a holographic printing device and a method which can print on a holographic medium at high speed.

### BACKGROUND ART

FIG. 1 is a view illustrating a method of printing hogels on a holographic medium through a related-art holographic printing device. The hogel printing method of the holographic printing device may refer to a method of calculating a whole fringe pattern and then segmenting the fringe pattern into hogels, and printing corresponding hogels at respective points by using a stage.

In this case, in order to print a whole image, as many hogels as a product of the number of hogels along a horizontal axis and the number of hogels along a vertical axis should be printed as shown in FIG. 2.

The above-described method may not have any great problem if the number of hogels is less than or equal to 10,000. However, in the case of large-screen holographic printing which is performed with more than 10,000 hogels, 24 hours or more may be required, and a serious noise may be generated in a holographic medium.

### DISCLOSURE

### Technical Problem

The disclosure has been developed in order to address the above-discussed deficiencies of the prior art, and an object of the disclosure is to provide a holographic printing device and a method which can print several hogels on a holographic medium at a time by using multiple optical heads, as a solution to reduce a holographic printing time.

### Technical Solution

According to an embodiment of the disclosure to achieve the above-described object, there is provided a holographic printing device including: a fringe pattern generation unit configured to generate a holographic fringe pattern and to segment the generated fringe pattern into hogels; a multiplexing unit configured to group the hogels segmented by the fringe pattern generation unit according to areas; and a plurality of optical heads configured to receive the grouped hogels and to print the hogels on corresponding areas of a holographic medium, respectively.

The plurality of optical heads may print hogels simultaneously.

The plurality of optical heads may include: a first optical head configured to print hogels on a first area of the holographic medium; and a second optical head configured to print hogels on a second area of the holographic medium.

The plurality of optical heads may include: a third optical head configured to print hogels on a third area of the holographic medium; and a fourth optical head configured to print hogels on a fourth area of the holographic medium.

The first area may be an area of a left upper portion of the holographic medium, the second area may be an area of a right upper portion of the holographic medium, the third area may be an area of a left lower portion of the holographic medium, and the fourth area may be an area of a right lower portion of the holographic medium.

The multiplexing unit may group hogels according to areas only when a size of the fringe pattern is larger than or equal to a threshold size.

The multiplexing unit may determine a number of areas to divide and sizes of the areas according to a shape of the fringe pattern.

According to another embodiment of the disclosure, there is provided a holographic printing method including: generating a holographic fringe pattern; segmenting the generated fringe pattern into hogels; grouping the hogels segmented by the fringe pattern generation unit according to areas; and printing the grouped hogels on corresponding areas of a holographic medium, respectively.

### Advantageous Effects

According to embodiments of the disclosure as described above, several hogels may be printed on a holographic medium at a time by using multiple optical heads, so that a holographic printing time may be reduced and thus even large screen holograms may be printed at high speed.

### DESCRIPTION OF DRAWINGS

FIGS. 1 and 2 are views illustrating a method of printing through a related-art holographic printing device;

FIG. 3 is a block diagram illustrating a holographic printing device according to an embodiment of the disclosure;

FIG. 4 is a view illustrating a result of dividing hogel printing areas;

FIG. 5 is a view illustrating a method of printing by the holographic printing device according to an embodiment of the disclosure; and

FIG. 6 is a flowchart provided to explain a holographic printing method according to another embodiment of the disclosure.

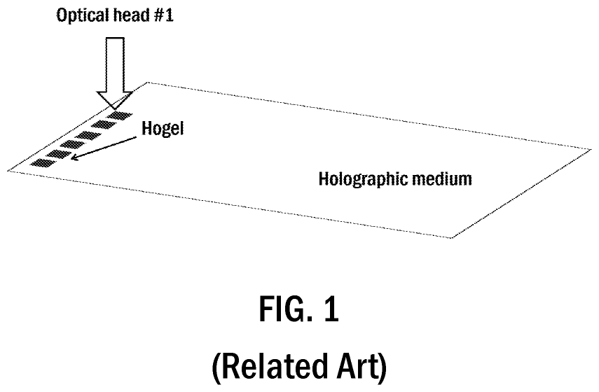

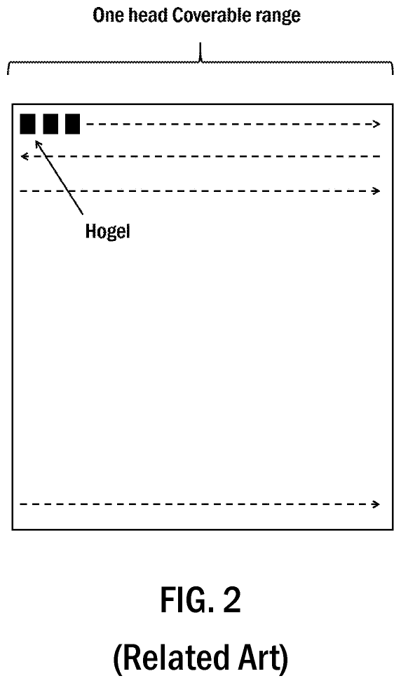

### BEST MODE

Hereinafter, the disclosure will be described in more detail with reference to the drawings.

An embodiment of the disclosure provides a holographic printing device using multiple optical heads and a method thereof.

A related-art holographic printing method prints hogels by using one optical head and requires much time to print. In an embodiment of the disclosure, a holographic printing method prints a plurality of hogels at a time by using a plurality of optical heads, so that a printing time may be reduced.

If the related-art holographic printing method is likened to operation of a computer having one core, the holographic printing method in an embodiment of the disclosure may be likened to operation of a computer having a plurality of cores.

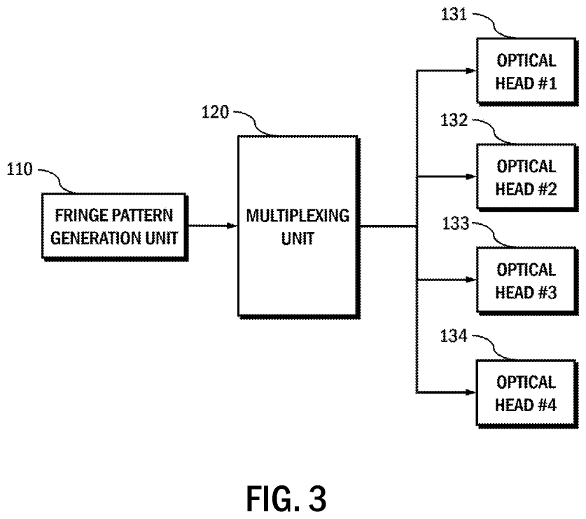

FIG. 3 is a block diagram of a holographic printing device according to an embodiment of the disclosure. The holographic printing device according to an embodiment of the disclosure may include a fringe pattern generation unit 110, a multiplexing unit 120, and a plurality of optical heads 131, 132, 133, 134.

The fringe pattern generation unit 110 generates a holographic fringe pattern containing information for restoring a hologram, segments the generated holographic fringe pattern into hogels and transmits the hogels to the multiplexing unit 120.

The multiplexing unit 120 divides the hogels by grouping the hogels segmented in the fringe pattern generation unit 110 according to recoding areas.

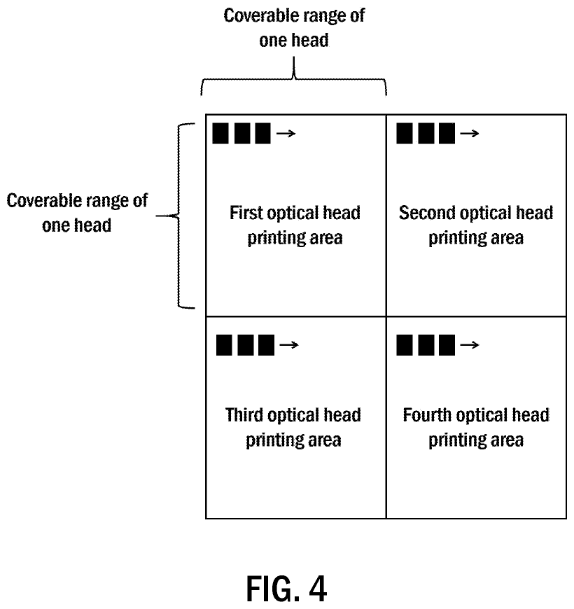

A result of dividing hogels according to printing areas by the multiplexing unit 120 is illustrated in FIG. 4. FIG. 4 illustrates a result of dividing a holographic medium for printing hogels into a plurality of printing areas, specifically, a left upper area, a right upper area, a left lower area, and a right lower area.

The plurality of optical heads 131, 132, 133, 134 print hogels transmitted from the multiplexing unit 120 on corresponding areas, respectively. Specifically, optical head #1 131 prints hogels on the left upper area of the holographic medium, optical head #2 132 prints hogels on the right upper area of the holographic medium, optical head #3 133 prints hogels on the left lower area of the holographic medium, and optical head #4 134 prints hogels on the right lower area of the holographic medium.

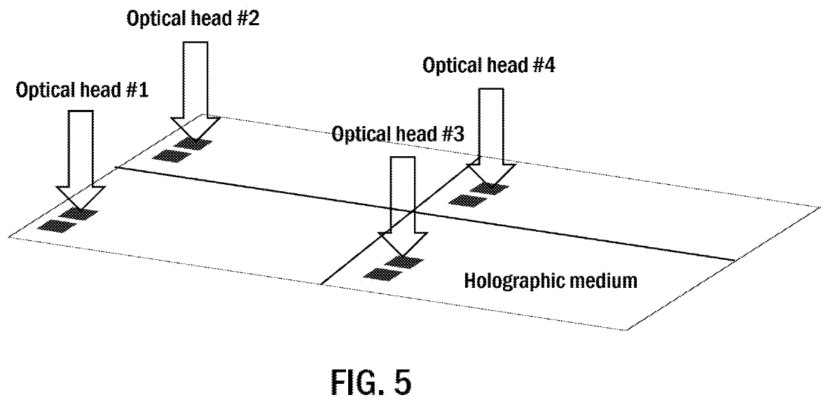

Printing of the hogels by the plurality of optical heads 131, 132, 133, 134 is achieved simultaneously. That is, as shown in FIG. 5, while optical head #1 131 prints hogels on the left upper area, optical head #2 132, optical head #3 133, and optical head #4 134 print hogels on the right upper area, the left lower area, and the right lower areas of the holographic medium, respectively and simultaneously.

When the number of optical heads is 4 as shown in FIG. 5, a printing speed may be four times faster than when the number of optical heads is 1, and the time required to print may be reduced by ¼.

The plurality of optical heads 131, 132, 133, 134 may include optical elements such as light sources, spatial light modulators (SLMs), lenses in order to print hogels on the holographic medium.

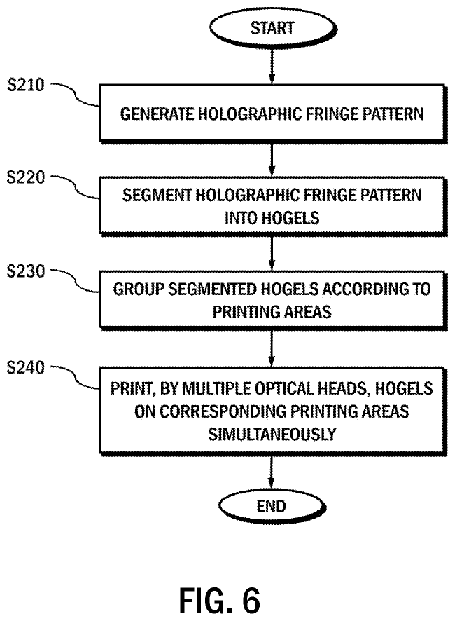

FIG. 6 is a flowchart provided to explain a holographic printing method according to another embodiment of the disclosure.

For holographic printing, the fringe pattern generation unit 110 generates a holographic fringe pattern (S210) and segments the generated holographic fringe pattern into hogels (S220).

Then, the multiplexing unit 120 divides the hogels by grouping the hogels segmented at step S220 according to printing areas (S230).

Thereafter, the plurality of optical heads 131, 132, 133, 134 print hogels allocated to their own printing areas on the areas allocated thereto according to a result of dividing at step S230 (S240).

Specifically, optical head #1 131 prints hogels on the left upper area of a holographic medium, optical head #2 132 prints hogels on the right upper area, optical head #3 133 prints hogels on the left lower area, and optical head #134 prints hogels on the right lower area, respectively, and printing of hogels is simultaneously performed.

Up to now, the holographic printing device using the plurality of optical heads and the method thereof have been described with reference to preferred embodiments.

The above-described embodiments provide a structure and a method for printing several hogels simultaneously in order to reduce a printing time, which is one of the big problems of holographic printing.

In a related-art holographic printing method, one optical head may be used and thus long time may be required to print by using the one optical head. However, in embodiments of the disclosure, a plurality of optical heads are used and the time required to print may be reduced, and accordingly, a printing time may also be reduced.

In the above-described embodiments, four optical heads are provided. However, this is merely an example for convenience of explanation. Any number of optical heads other than 4 may be implemented.

In the above-described embodiments, hogels are divided according to printing areas by the multiplexing unit 220. However, this operation may be implemented to be selectively performed. For example, hogels may be grouped according to areas only when a size of a fringe pattern is larger than or equal to a threshold size or a size of a holographic medium is larger than or equal to a threshold size.

Furthermore, the number of printing areas and sizes thereof may be implemented to be variable, rather than being fixed. That is, the multiplexing unit 220 may determine the number of areas to divide and sizes thereof according to a shape of a fringe pattern.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A holographic printing device comprising:
a fringe pattern generation unit configured to generate a holographic fringe pattern and to segment the generated fringe pattern into hogels;
a multiplexing unit configured to group the hogels segmented by the fringe pattern generation unit according to areas; and
a plurality of optical heads configured to receive the grouped hogels and to print the hogels on corresponding areas of a holographic medium, respectively.

2. The holographic printing device of claim 1, wherein the plurality of optical heads are configured to print hogels simultaneously.

3. The holographic printing device of claim 1, wherein the plurality of optical heads comprise:
a first optical head configured to print hogels on a first area of the holographic medium; and
a second optical head configured to print hogels on a second area of the holographic medium.

4. The holographic printing device of claim 3, wherein the plurality of optical heads comprise:
a third optical head configured to print hogels on a third area of the holographic medium; and
a fourth optical head configured to print hogels on a fourth area of the holographic medium.

5. The holographic printing device of claim 4, wherein the first area is an area of a left upper portion of the holographic medium,
wherein the second area is an area of a right upper portion of the holographic medium,
wherein the third area is an area of a left lower portion of the holographic medium, and
wherein the fourth area is an area of a right lower portion of the holographic medium.

6. The holographic printing device of claim 1, wherein the multiplexing unit is configured to group hogels according to areas only when a size of the fringe pattern is larger than or equal to a threshold size.

7. The holographic printing device of claim 1, wherein the multiplexing unit is configured to determine a number of areas to divide and sizes of the areas according to a shape of the fringe pattern.

8. A holographic printing method comprising:
generating a holographic fringe pattern;
segmenting the generated fringe pattern into hogels;
grouping the hogels segmented by the fringe pattern generation unit according to areas; and
printing the grouped hogels on corresponding areas of a holographic medium, respectively.
